(19) United States
(12) Patent Application Publication
(10) Pub. No.: US 2021/0195618 A1
(43) Pub. Date: Jun. 24, 2021

(54) SDM IAB TRANSMISSION

(71) Applicant: NEC CORPORATION, Tokyo (JP)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 17/267,831

(22) PCT Filed: Aug. 24, 2018
(86) PCT No.: PCT/CN2018/102356

§ 371 Date: Feb. 11, 2021

(51) Int. Cl. H04W 72/12; H04W 52/24; H04W 52/46; H04B 7/06; H04W 88/14; H04W 72/04; H04L 5/16

(52) U.S. Cl. CPC H04W 72/1268; H04W 72/1257; H04W 52/242; H04L 5/16; H04B 7/0697; H04W 88/14; H04W 72/042; H04W 52/46

(57) ABSTRACT

Embodiments of the present disclosure provide methods, devices and computer readable media for Space Division Multiplexing (SDM) Integrated Access and Backhaul (IAB) transmission. According to a method for communication, a first device determines a first set of transmission resources related to first data transmission between the first device and a second device operating in a half-duplex manner as a relay between the first device and a third device. The first device transmits to the second device scheduling information indicating the first set of transmission resources, such that the second device determines, based on the first set of transmission resources, a second set of transmission resources to be used for second data transmission between the second device and the third device. The embodiments of the present disclosure support SDM for IAB transmission.

### FIELD

Embodiments of the present disclosure generally relate to wireless communication, and in particular, to a method, a device and a computer readable medium for Space Division Multiplexing (SDM) Integrated Access and Backhaul (IAB) transmission.

### BACKGROUND

The latest developments of the 3GPP standards are referred to as Long Term Evolution (LTE) of Evolved Packet Core (EPC) network and Evolved UMTS Terrestrial Radio Access Network (E-UTRAN), also commonly termed as ‘4G’. In addition, the term ‘5G New Radio (NR)’ refers to an evolving communication technology that is expected to support a variety of applications and services. 5G NR is part of a continuous mobile broadband evolution promulgated by Third Generation Partnership Project (3GPP) to meet new requirements associated with latency, reliability, security, scalability (e.g., with Internet of Things (IoTz)), and other requirements. Some aspects of 5G NR may be based on the 4G Long Term Evolution (LTE) standard.

Recently, regarding IAB deployment scenarios, it is agreed that in-band IAB scenarios including TDM/FDM/SDM of an access link and a backhaul link subject to half-duplex constraint at an IAB node should be supported. In particular, it is agreed that downlink IAB transmission (transmission from an IAB node to a child IAB node or a UE directly communicating with the IAB node) should be scheduled by the IAB node itself, and uplink IAB transmission (transmission from an IAB node to its parent node) should be scheduled by the parent node. However, MIMO operations for an SDM IAB node are still not clear and need to be studied.

### SUMMARY

In general, example embodiments of the present disclosure provide methods, devices and computer readable media for SDM IAB transmission.

In a first aspect, there is provided a method for communication. The method comprises determining, at a first device, a first set of transmission resources related to first data transmission between the first device and a second device operating in a half-duplex manner as a relay between the first device and a third device. The method also comprises transmitting to the second device scheduling information indicating the first set of transmission resources, such that the second device determines, based on the first set of transmission resources, a second set of transmission resources to be used for second data transmission between the second device and the third device.

In a second aspect, there is provided a method for communication. The method comprises receiving from a first device, by a second device operating in a half-duplex manner as a relay between the first device and a third device, first scheduling information indicating a first set of transmission resources related to first data transmission between the first device and the second device. The method also comprises determining, based on the first set of transmission resources, a second set of transmission resources to be used for second data transmission between the second device and the third device. The method further comprises transmitting to the third device second scheduling information indicating the second set of transmission resources.

In a third aspect, there is provided a device. The device comprises a processor and a memory storing instructions. The memory and the instructions are configured, with the processor, to cause the device to perform the method according to the first aspect.

In a fourth aspect, there is provided a device. The device comprises a processor and a memory storing instructions. The memory and the instructions are configured, with the processor, to cause the device to perform the method according to the second aspect.

In a fifth aspect, there is provided a computer readable medium having instructions stored thereon. The instructions, when executed on at least one processor of a device, cause the device to carry out the method according to the first aspect.

In a sixth aspect, there is provided a computer readable medium having instructions stored thereon. The instructions, when executed on at least one processor of a device, cause the device to carry out the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 shows an example process of communication among a first device, a second device, and a third device in accordance with some embodiments of the present disclosure;

FIG. 3 shows an example relation between a first set of transmission resources and a second set of transmission resources in accordance with some embodiments of the present disclosure;

FIG. 4A shows an example process of communication between the first device and the second device for implementing SDM transmission of the second device in a transmitting mode in accordance with some embodiments of the present disclosure;

FIG. 4B shows another example process of communication between the first device and the second device for implementing SDM transmission of the second device in a transmitting mode in accordance with some embodiments of the present disclosure;

FIG. 5 shows an example process of communication between the first device and the second device for the second device requesting the first device to transmit scheduling information in accordance with some embodiments of the present disclosure;

FIG. 6 shows an example process of communication among the first device, the second device, and the third device for power control in accordance with some embodiments of the present disclosure;

FIG. 7 shows another example process of communication among the first device, the second device, and the third device for power control in accordance with some embodiments of the present disclosure;

FIG. 8 shows an example process of communication among the first device, the second device, and the third device with a confirmation mechanism in accordance with some embodiments of the present disclosure;

FIG. 9A shows an example of activation and deactivation of special scheduling with specific signaling in accordance with some embodiments of the present disclosure;

FIG. 9B shows another example of activation and deactivation of special scheduling with specific signaling in accordance with some embodiments of the present disclosure;

FIG. 10 shows a flowchart of an example method in accordance with some embodiments of the present disclosure;

FIG. 11 shows a flowchart of another example method in accordance with some embodiments of the present disclosure; and

FIG. 12 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

As used herein, the term “transmission/reception point” may generally indicate a station communicating with the user equipment. However, the transmission/reception point may be referred to as different terms such as a base station (BS), a cell, a Node-B, an evolved Node-B (eNB), a next generation NodeB (gNB), a Transmission Reception Point (TRP), a sector, a site, a base transceiver system (BTS), an access point (AP), a relay node (RN), a remote radio head (RRH), a radio unit (RU), an antenna, and the like.

That is, in the context of the present disclosure, the transmission/reception point, the base station (BS), or the cell may be construed as an inclusive concept indicating a portion of an area or a function covered by a base station controller (BSC) in code division multiple access (CDMA), a Node-B in WCDMA, an eNB or a sector (a site) in LTE, a gNB or a TRP in NR, and the like. Accordingly, a concept of the transmission/reception point, the base station (BS), and/or the cell may include a variety of coverage areas such as a megacell, a macrocell, a microcell, a picocell, a femtocell, and the like. Furthermore, such concept may include a communication range of the relay node (RN), the remote radio head (RRH), or the radio unit (RU).

In the context of the present disclosure, the user equipment and the transmission/reception point may be two transmission/reception subjects, having an inclusive meaning, which are used to embody the technology and the technical concept disclosed herein, and may not be limited to a specific term or word. Furthermore, the user equipment and the transmission/reception point may be uplink or downlink transmission/reception subjects, having an inclusive meaning, which are used to embody the technology and the technical concept disclosed in connection with the present embodiment, and may not be limited to a specific term or word. Herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

FIG. 1 is a schematic diagram of a communication environment 100 in which some embodiments of the present disclosure can be implemented. As shown in FIG. 1, the communication environment 100 may include a first device 110, a second device 120, and a third device 130. In some embodiments, the second device 120 may operate in a half-duplex manner as a relay between the first device 110 and the third device 130. This means that the first device 110 and the third device 130 may indirectly communicate with each other through the second device 120.

In particular, the first device 110 may transmit signals to the second device 120 via a communication link 112 and receive signals from the second device 120 via a communication link 114, and the third device 130 may transmit signals to the second device 120 via a communication link 124 and receive signals from the second device 120 via a communication link 122. As mentioned, the second device 120 may operate in a half-duplex manner. That is, the second device 120 may not perform transmitting and receiving simultaneously.

For example, the second device 120 may receive signals from the first device 110 via the communication link 112 and from the third device 130 via the communication link 124 simultaneously, and may transmit signals to the first device 110 via the communication link 114 and to the third device 130 via the communication link 122 simultaneously. However, the second device 120 may not transmit signals to the first device 110 via the communication link 114 and receive signals from the third device 130 via the communication link 124 simultaneously, or receive signals from the first device 110 via the communication link 112 and transmit signals to the third device 130 via the communication link 122 simultaneously.

In some scenarios, the first device 110 may be a gNB, the third device 130 may be a terminal device (such as a UE), and the second device 120 may be a relay node between the gNB and the UE. In such scenarios, the first device 110 may also be referred to as an IAB donor, and the second device 120 may also be referred to as an IAB node. In some scenarios, the second device 120 may be an IAB node, the first device 110 may be another IAB node which is a parent node of the second device 120, and the third device 130 may be a terminal device (such as a UE) or a further IAB node which is a child node of the second device 120. The communication links 112 and 114 may be referred to as a backhaul downlink and a backhaul uplink, respectively, and may be referred to as backhaul links or parent links, collectively. The communication links 122 and 124 may be referred to as an access downlink and an access uplink, respectively, and may be referred to as access links or child links, collectively.

In some other scenarios, either or both of the first device 110 and the third device 130 may also be a relay, such as an IAB node. For example, this may be the case in a multi-hop backhauling scenario. If the third device 130 is a relay, the communication links 122 and 124 may also be backhaul links, rather than access links. In the case of the second and third devices 120 and 130 are both relays, the communication links 122 and 124 may be also referred to as child backhaul links. Accordingly, various embodiments described herein with respect to a backhaul link and an access link may also be applicable to these scenarios, in which the access link is replaced by another backhaul link.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the number of devices as shown in FIG. 1 are only for the purpose of illustration without suggesting any limitations. Actually, the communication environment 100 may include any suitable number of devices adapted for implementing embodiments of the present disclosure. It is also to be understood that the term “device” as used herein may be a network device or a terminal device in different communication scenarios.

In recent development of 5G NR, it is agreed that mechanisms for efficient TDM/FDM/SDM multiplexing of access/backhaul traffic across multiple hops considering an IAB node half-duplex constraint should be studied. There are several solutions for different multiplexing options which can be further studied. The first solution may be mechanisms for orthogonal partitioning of time slots or frequency resources between access and backhaul links across one or multiple hops.

The second solution may be utilization of different DL/UL slot configurations for access and backhaul links. The third solution may be DL and UL power control enhancements and timing requirements to allow for intra-panel FDM and SDM of backhaul and access links. The fourth solution may be interference management including cross-link interference. However, as indicated above, MIMO operations for an SDM IAB node are still not clear and also need to be studied.

In order to solve the above technical problems and potentially other technical problems in conventional solutions, embodiments of the present disclosure provide methods, devices and computer readable media for SDM IAB transmission. The embodiments of the present disclosure support backhaul transmission from an IAB node to an IAB donor, and thus support SDM for IAB transmission of the IAB node. Principles and implementations of the present disclosure will be described in detail below with reference to the figures.

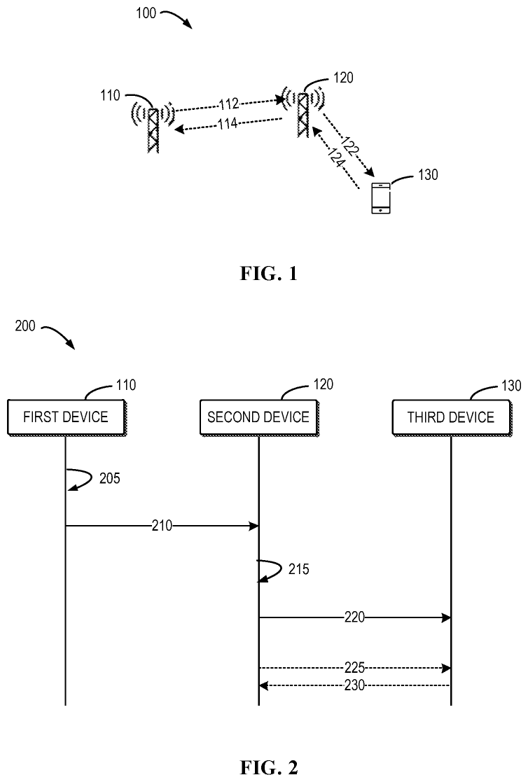

FIG. 2 shows an example process 200 of communication among a first device, a second device, and a third device in accordance with some embodiments of the present disclosure. For the purpose of discussion, the example process 200 will be described with reference to FIG. 1. In some embodiments, the example process 200 may involve the first, second, and third devices 110, 120, and 130 in FIG. 1.

As shown in FIG. 2, the first device 110 determines 205 a first set of transmission resources related to first data transmission between the first device 110 and the second device 120. As will be detailed later, the first set of transmission resources are used for the second device 120 to determine transmission resources used for second data transmission between the second device 120 and the third device 130. The purpose is to eliminate or reduce interference between the first data transmission and the second data transmission. In the following, the first data transmission and the second data transmission may also be referred to as S1 and S2 respectively for short.

In some embodiments, the first device 110 may determine a set of transmission resources to be used for the first data transmission as the first set of transmission resources. Alternatively, the first device 110 may determine a set of transmission resources not to be used for the first data transmission as the first set of transmission resources. In this way, the first device 110 may inform to the second device 120 some explicit information regarding the transmission resources associated with the first data transmission.

The first device 110 transmits 210 to the second device 120 first scheduling information, which indicates the first set of transmission resources. Correspondingly, the second device 120 receives 210 the first scheduling information from the first device 110. In the following, the scheduling related to the first scheduling information may also be referred to as special scheduling, because normal scheduling information transmitted by the first device 110 to the second device 120 is used for scheduling data transmission between them, whereas the intention of the first scheduling information is to coordinate the scheduling of data transmission between the second device 120 and the third device 130, which data transmission may also be referred to as special transmission herein.

The second device 120 determines 215 a second set of transmission resources based on the first set of transmission resources, which is to be used for second data transmission between the second device 120 and the third device 130. As mentioned, the second set of transmission resources may be determined such that the second data transmission is not to be or less interfered by the first data transmission. That is, time/frequency/spatial resource allocations for the second data transmission are confined by the special transmission.

For example, if the first set of transmission resources is a set of transmission resources to be used for the first data transmission, the second device 120 may determine a complementary set of the first set of transmission resources with respect to a universal set of all available transmission resources. In other words, the second device 120 determines the complementary set as the second set of transmission resources, so that the first data transmission and the second data transmission may be performed using different transmission resources. Thus, the interference between them may be reduced or even eliminated.

Alternatively, if the first set of transmission resources is a set of transmission resources not to be used for the first data transmission, the second device 120 may determine a subset of the first set of transmission resources as the second set of transmission resources. In other words, the second device 120 determines the subset as the second set of transmission resources, so that the transmission resources used for the second data transmission are not to be used for the first data transmission. Thus, the interference between them may be reduced or even eliminated.

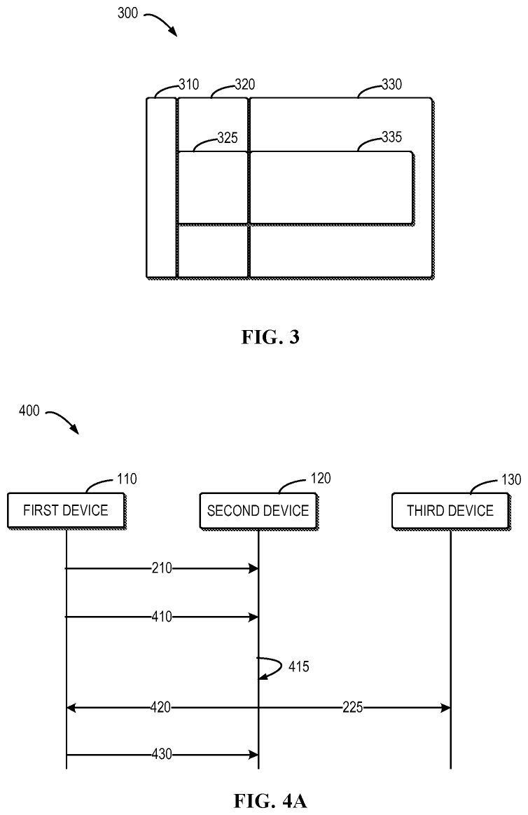

FIG. 3 shows an example relation 300 between the first set of transmission resources and the second set of transmission resources in accordance with some embodiments of the present disclosure. In the example relation 300 as shown in FIG. 3, the second set of transmission resources is a subset of the first set of transmission resources.

In particular, the control resource set (CORSET) as defined in 3GPP new radio (NR) systems may be denoted as 310 and may be optionally configured. The first device 110 may determine the first set of transmission resources including a DMRS set 320 and time/frequency resources 330 for the first data transmission, such as in the uplink of backhaul link. Accordingly, based on the DMRS set 320 and the time/frequency resources 330, the second device 120 may determine the second set of transmission resources including a DMRS set 325 and time/frequency resources 335 for the second data transmission, such as in the downlink of access link. As shown, the DMRS set 325 and the time/frequency resources 335 are subsets of the DMRS set 320 and the time/frequency resources 330, respectively.

Referring back to FIG. 2, after determining the second set of transmission resources for second data transmission between the second device 120 and the third device 130, the second device 120 transmits 220 to the third device 130 second scheduling information, which indicates the second set of transmission resources. Therefore, the second device 120 may communicate with the third device 130 using the second set of transmission resources.

For example, the second device 120 may transmit 225 signals to the third device 130, and may receive 230 signals from the third device 130. It is noted that since the second set of transmission resources are selected based on the first set of transmission resources related to the first data transmission, the second data transmission may not be or less interfered by the first data transmission.

In addition, the scheduling indicated by the second scheduling information may need not to be exchanged to the first device 110. However, the first device 110 may be aware of active resources in the communication links 122 and 124, and thus controllable interference from the communication links 122 and 124 to the communication links 112 and 114 may be also available for the first device 110.

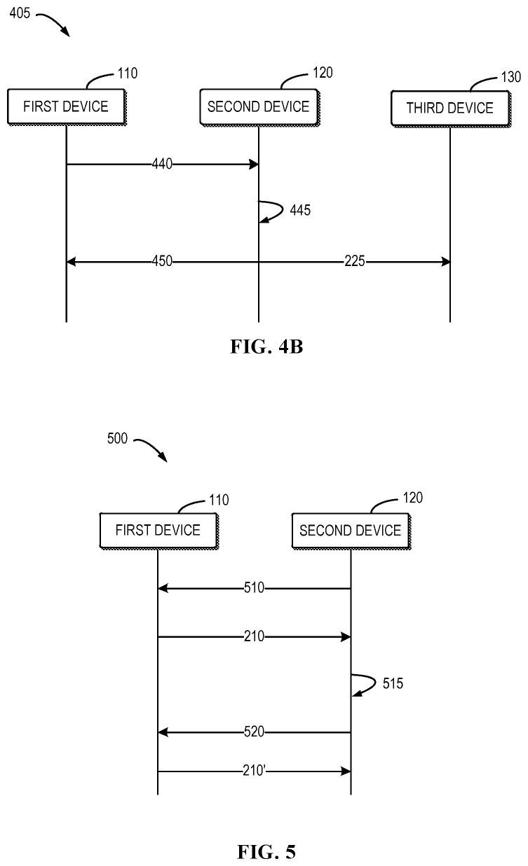

FIG. 4A shows an example process 400 of communication between the first device 110 and the second device 120 for implementing SDM transmission of the second device 120 in a transmitting mode in accordance with some embodiments of the present disclosure. In other words, the example process 400 may be used to schedule simultaneous transmissions from the second device 120 to the first device 110 and to the third device 130. In this way, the two transmissions may be multiplexed, for example, by spatial division.

As shown in FIG. 4A and described with reference to FIG. 2, the first device 110 transmits 210 the first scheduling information to the second device 120. In addition to the first scheduling information, the first device 110 may transmit 410 to the second device 120 third scheduling information, which indicates a third set of transmission resources, that is to be used for transmission from the second device 120 to the first device 110, such as a PUSCH transmission. The third set of transmission resources includes the same time and frequency resources as the second set of transmission resources, but includes a different spatial resource from the second set of transmission resources. Thus, the transmission from the second device 120 to the first device 110 is separated from the second data transmission in spatial domain.

Upon receiving 410 the third scheduling information from the first device 110, the second device 120 determines 415 the third set of transmission resources from the third scheduling information. Then, the second device 120 may transmit 420 signals to the first device 110 using the third set of transmission resources and also transmit 225 signals to the third device 130 using the second set of transmission resources, as described above with reference to FIG. 2. In this scenario, the second device 120 may be regarded as a virtual UE with disabled data transmission for the first device 110. Thus, the first device 110 may be considered to have two UEs, the first UE corresponds to the data transmission S1, and the second UE corresponds to the data transmission S2 but which is regarded as disabled from a view of the first device 110. In some embodiments, a DMRS for S2 transmitted in the access link may be estimated at the first device 110 in the backhaul link for interference cancellation.

In some embodiments, the scheduling indicated by the first scheduling information may be semi-persistent scheduling, for example, which may be scheduled by a DCI scrambled by an identifier of CS-RNTI in NR. Thus, the first device 110 may transmit 430 new semi-persistent scheduling information to the second device 120, to reschedule the first set of transmission resources including time resources, frequency resources (in terms of RBs), antenna ports or the like. In contrast, the scheduling indicated by the third scheduling information may be dynamic scheduling, which can be an addition to the scheduling indicated by the first scheduling information, rather than colliding or overwriting the first scheduling.

FIG. 4B shows another example process 405 of communication between the first device 110 and the second device 120 for implementing SDM transmission of the second device 120 in a transmitting mode in accordance with some embodiments of the present disclosure. In other words, the example process 405 may also be used to schedule simultaneous transmissions from the second device 120 to the first device 110 and to the third device 130. In this way, the two transmissions may be multiplexed, for example, by spatial division.

As shown in FIG. 4B, the first device 110 transmits 440 the first scheduling information including both the first set of transmission resources and the third set of transmission resources. In other words, the first device 110 indicates the third set of transmission resources in the first scheduling information, instead of transmitting separate scheduling information.

In this event, the second device 120 determines 445 the third set of transmission resources along with the first set of transmission resources from the first scheduling information. Accordingly, the second device 120 transmits 450 to the first device 110 using the third set of transmission resources and transmits 225 to the third device using the second set of transmission resources, as described above with reference to FIG. 2. Again, the two transmissions from the second device 120 to the first device 110 and to the third device 130 may be spatial division multiplexed.

FIG. 5 shows an example process 500 of communication between the first device 110 and the second device 120 for the second device 120 requesting the first device 110 to transmit scheduling information in accordance with some embodiments of the present disclosure. In other words, in the example process 500, the first device 110 may perform the special scheduling based on a request from the second device 120. In this way, the second device 120 may be more active in the special scheduling and transmission, instead of being completely passive.

As shown in FIG. 5, the second device 120 may transmit 510 to the first device 110 a scheduling request, which requests the first device 110 to schedule transmission resources for the second data transmission. For example, this may be the case where the first device 110 has not performed the special scheduling currently. In some embodiments, the scheduling request may carry only one indication bit.

After receiving 510 the scheduling request from the second device 120, the first device 110 may determine the first set of transmission resources related to the first data transmission, as described with reference to FIG. 2.

In some embodiments, the second device 120 may determine 515 that the second set of transmission resources is insufficient for the second data transmission. In such a case, the second device 120 transmits 520 to the first device 110, information indicates that the second set of transmission resources is insufficient. As an example, the information may be dedicated buffer status report (BSR), which reports traffic load information between the second device 120 and the third device 130 in access link to the first device 110. In other examples, the information may be any other suitable signaling.

After receiving 520 the information from the second device 120, the first device 110 may transmit 210′ updated first scheduling information to the second device 120. The updated first scheduling information may indicate an updated first set of transmission resources, which may result in an updated second set of transmission resources comprising more transmission resources than the second set of transmission resources.

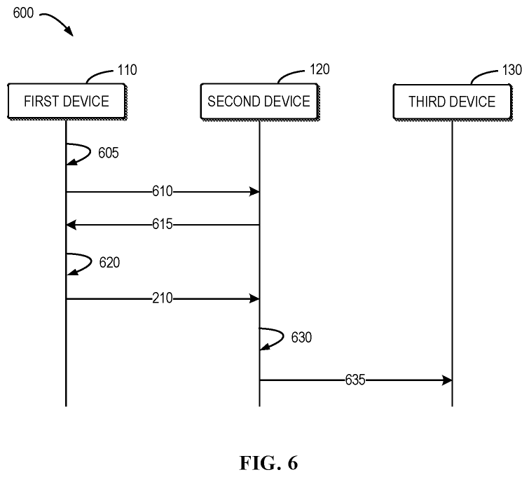

FIG. 6 shows an example process 600 of communication among the first device 110, the second device 120, and the third device 130 for power coordination in accordance with some embodiments of the present disclosure. In some embodiments, the example process 600 may be used to coordinate transmission power of transmission from the second device 120 to the third device 130. In this way, the power control of the communication link (for example, the access link) between the second device 120 and the third device 130 may be performed taking into account the communication link (for example, the backhaul link) between the first device 110 and the second device 120.

As shown in FIG. 6, the first device 110 obtains 605 a first path loss estimate of a first communication link 112 or 114 between the first device 110 and the second device 120, for example, the backhaul link. Additionally, the first device 110 may request 610 from the second device 120 a second path loss estimate of a second communication link 122 or 124 between the second device 120 and the third device 130, for example, the access link.

Upon receiving 610 the request from the first device 110, the second device 120 may transmit 615 to the first device 110 the path loss estimate of the second communication link 122 or 124 between the second device 120 and the third device 130. Correspondingly, the first device 110 receives 615 the second path loss estimate from the second device 120.

The first device 110 then determines 620 a power control based on any one or a combination of the first and second path loss estimates. The power control is used for transmission from the second communication 120 to the third device 130. The first device 110 transmits 210 to the second device 120 the first scheduling information including the determined power control. That is, the first device 110 may indicate the determined power control in the first scheduling information.

After receiving 210 the first scheduling information from the first device 110, the second device 120 obtains 630 the power control from the first scheduling information. Then, the second device 120 may apply 635 the power control to the transmission from the second device 120 to the third device 130. As an example, this power control may be expressed by equations as below.

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( {q}_{d} ) + {PL}_{b , f , c} ( {q}_{d} ) + {Δ}_{TF , b , f , c} ( i ) + {f}_{b , f , c} ( i , l )\end{matrix} \}$$

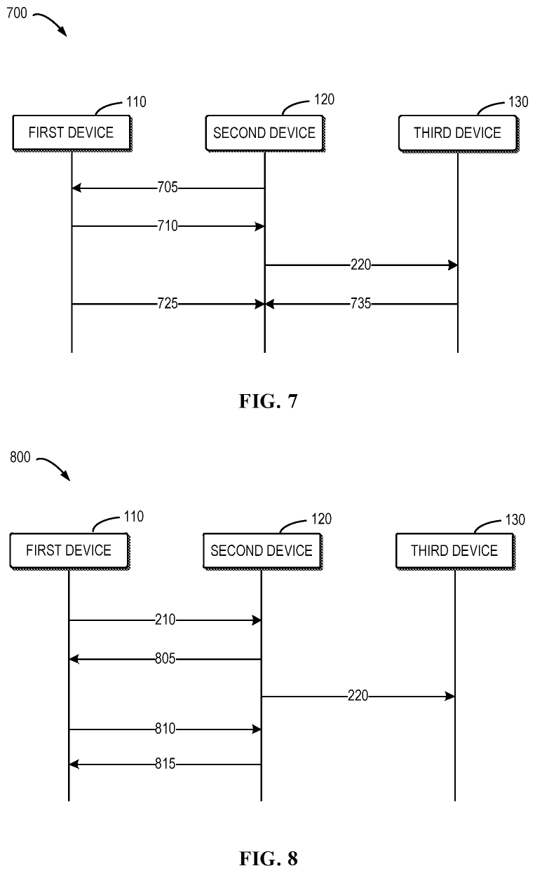

FIG. 7 shows another example process 700 of communication among the first device 110, the second device 120, and the third device 130 for power coordination in accordance with some embodiments of the present disclosure. In some embodiments, the example process 700 may be used to coordinate the transmission power of transmission from the first device 110 to the second device 120 (for example, in the backhaul link), so as to reduce interference with the transmission from the third device 130 to the second device 120. In this way, the transmission from the third device 130 (for example, a UE) may not be severely interfered by the transmission from the first device 110, for example, a gNB which may have much higher transmission power than a UE.

As shown in FIG. 7, the second device 120 transmits 705 to the first device 110 a power coordination request for requesting the first device 110 to adjust transmission power of transmission from the first device 110 to the second device 120 in the backhaul link. Correspondingly, the first device 110 receives 705 the power coordination request from the second device 120.

If the first device 110 determines that the transmission power is to be adjusted, the first device 110 may transmit 710 to the second device 120 confirmation for the power coordination request. Accordingly, the first device 110 may transmit 725 to the second device 120 with the adjusted power in the backhaul link.

After the second device 120 receives 710 from the first device 110 confirmation for the power coordination request, the second device 120 may transmit 220 to the third device 130 the second scheduling information including power control information for controlling transmission power of transmission from the third device 130 to the second device 120. In other words, the second device 120 may indicate this power control in the second scheduling information. Then, the second device 120 may receive 725 from the first device 110 with the adjusted power in the backhaul link and also receive 735 from the third device 130 with power under the power control indicated by the second device 120 in the access link.

FIG. 8 shows an example process 800 of communication among the first device 110, the second device 120, and the third device 130 with a confirmation mechanism in accordance with some embodiments of the present disclosure. In other words, in the example process 800, the second device 120 may transmit confirmation information to the first device 110 when receiving special scheduling information. In this way, reliability of the special scheduling and transmission may be improved.

As shown in FIG. 8, upon receiving 210 the first scheduling information, the second device may transmit 805 to the first device 110 confirmation for the first scheduling information. Correspondingly, the first device 110 may receive 805 the confirmation from the second device 120.

In some embodiments, the first device 110 may transmit 810 to the second device 120 a deactivation indication for deactivating the scheduling information. Correspondingly, the second device 120 may receive 810 the deactivation indication from the first device 110. In response, the second device 120 may transmit 815 to the first device 110 confirmation for the deactivation indication. Correspondingly, the first device 110 receives 815 the confirmation for the deactivation indication from the second device 120.

In some embodiments, the above-mentioned confirmation may also be referred to as grant confirmation. If the special scheduling is activated/deactivated by a DL DCI, the second device 120 (such as an IAB node) may transmit the grant confirmation (such as ACK/NACK) on a PUCCH in the backhaul link indicated by a PUCCH resource indicator in the activation DCI. If the special scheduling is activated/deactivated by a UL DCI, the second device 120 (such as an IAB node) may transmit the grant confirmation on a MAC-CE or a dedicated PUCCH via ACK/NACK in the backhaul link.

There may be various ways for the first device 110 to indicate the special scheduling information to the second device 120. Table 1 as below shows different methods for the special scheduling signaling. These various methods will be described with further details with reference to following Tables 2-10. It is noted that the terms and abbreviations used in these tables may have the same meanings as that defined in 3GPP specifications.

TABLE 1

| Methods | | Content |
|---|---|---|
| All RRC configured | | Resource allocation (SLIV, or RB, or port) |
| | | Periodicity (including slot format) |
| RRC + | RRC | Resource allocation set (SLIV or RB, or port) |
| MAC-CE or | | Periodicities (including slot format) |
| DCI | MAC-CE or | Activation/Deactivation and resource |
| | GC DCI | selection (bitmap) |
| RRC + DCI | RRC | Periodicity (including slot format) |
| | CS-RNTI | Activation/Deactivation and resource |
| | DCI | allocation (SLIV, RB or port by |
| | | DCI0_0, 0_1, 1_0, 1_1) |
| C-RNTI DCI | | resource allocation (RB, or port, |
| | | SLIV by DCI0_0, 0_1, 1_0, 1_1) |

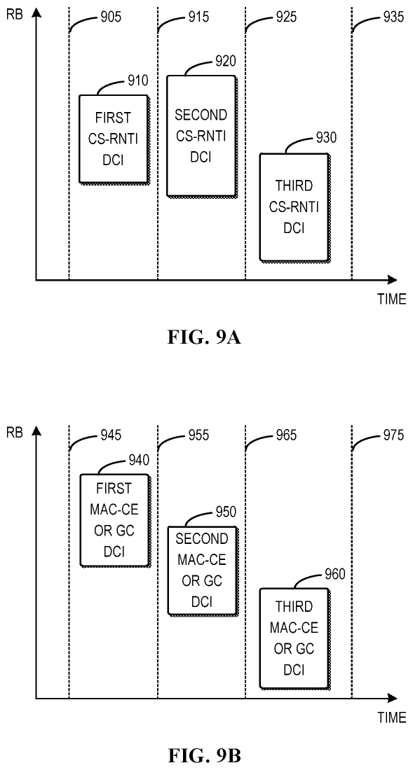

As illustrated in Table 1, the first device 110 may indicate the special scheduling information in a radio resource control (RRC) message, a medium access control-control element (MAC-CE), downlink control information (DCI), dedicated DCI or the like. Correspondingly, the second device 120 may obtain the special scheduling information from these signaling messages. As similar to the NR system, resource allocation is used to indicate any of time domain resources such as the starting and duration of allocated symbols in a slot (SLIV), frequency domain resources such as a number of resource blocks (RB), and spatial domain resources such as a number of antenna ports. Periodicity indication is to configure a period where a slot format pattern is indicated for available downlink/uplink transmission for backhaul/access links. The time domain granularity of slot format pattern can be slot-based or non-slot based in NR system. In this way, the special scheduling may be flexibly performed according to practical implementation and design requirements. Two example embodiments of these methods will be first described with reference to FIGS. 9A and 9B.

FIG. 9A shows an example of activation and deactivation of special scheduling with specific signaling in accordance with some embodiments of the present disclosure. As shown, the special transmission may be activated at 905 by a first CS-RNTI DCI 910. The specific transmission resources for the special transmission may be indicated in the first CS-RNTI DCI 910 and may be valid in the time period between 905 and 915.

At 915, the specific transmission resources for the special transmission may be reconfigured by a second CS-RNTI DCI 920. For example, more RBs may be configured for the special transmission. The configuration indicated by the second CS-RNTI DCI 920 may be valid in the time period between 915 and 925.

At 925, the specific transmission resources for the special transmission may be reconfigured by a third CS-RNTI DCI 930. For example, different antenna ports may be configured for the special transmission. The configuration indicated by the third CS-RNTI DCI 930 may be valid in the time period between 925 and 935. At 935, the special transmission may be deactivated, for example, as instructed in the third CS-RNTI DCI 930 or in a further CS-RNTI DCI.

FIG. 9B shows another example of activation and deactivation of special scheduling with specific signaling in accordance with some embodiments of the present disclosure. FIG. 9B is similar to FIG. 9A, with the difference in that the specific transmission resources are configured through MAC-CEs or group-common (GC) DCIs such as INT-DCIs instead of CS-RNTI DCIs.

As shown, a first MAC-CE or GC DCI 940, a second MAC-CE or GC DCI 950, and a third MAC-CE or GC DCI 960 are transmitted at 945, 955, and 965, respectively, each selecting one resource allocation from a set of more than one resource allocations configured by the RRC. The special transmission is activated at 945 and deactivated at 975. The configurations of transmission resources for the special transmission indicated by the first MAC-CE or GC DCI 940, the second MAC-CE or GC DCI 950, and the third MAC-CE or GC DCI 960 are valid in the time period between 945 and 955, the time period between 955 and 965, and the time period between 955 and 965, respectively.

As an example of the “All RRC configured” method in Table 1, a semi-static configuration can be configured for special transmission. This can be achieved by an RRC configured grant field in an RRC message, as shown in below Table 2.

TABLE 2

| RRC configured grant Field | Usage in special scheduling |
|---|---|
| cg-DMRS-Configuration | DMRS pattern configuration |
| periodicity | A period with indicated slot |
| | format |
| timeDomainOffset | Offset of a resource with |
| | respect to SFN = 0 in time |
| | domain |
| timeDomainAllocation | startSymbolAndLength in a |
| | slot (SLIV) |
| frequencyDomainAllocation | Frequency resource |
| | allocation (RB) |
| antennaPort | Antenna ports allocation |
| dmrs-SeqInitialization | For the seed of DMRS-RS |

As an example of the “RRC+MAC-CE or DCI” method in Table 1, the GC DCI and the MAC-CE may be used together with a RRC message to indicate the special scheduling information. An example of the GC DCI for this purpose is shown in below Table 3.

TABLE 3
GC DCI

| DCI format | Field | Usage in special scheduling |
|---|---|---|
| DCI 2_1 | Indicator for access link | “0” = backhaul link; |
| | | “1” = access link |
| | bitmap | all “0” = deactivation |
| | | any of “1” = activation or |
| | | selection |

An example of the MAC-CE for this purpose is shown in below Table 4.

TABLE 4
MAC-CE

| field | Usage in special scheduling |
|---|---|
| LGID | Logical channel ID |
| bitmap | all “0” = deactivation |
| | any of “1” = activation or |
| | selection |

As an example of “RRC+DCI” or “C-RNTI/CS-RNTI DCI” method in Table 1, below Table 5 shows an example of special scheduling by DL-DCI.

TABLE 5

| | | Usage in |
|---|---|---|
| | | special scheduling |
| | | Special value |
| BL DL-DCI Field | | reserved for |
| (C-RNTI, CS-RNTI) | | indicating activation |
| Indicator | NDI, MCS, RV, | and deactivation of |
| for special transmission | HARQ, DAT | special transmission |
| DCI1_0 | Frequency domain | Frequency domain |
| (RB-level RA) | resource assignment | resource assignment |
| | Time domain | Time domain resource |
| | resource assignment | |
| | TPC command for | Power coordination |
| | PUCCH | between backhaul and |
| | | access links |
| DCI1_1 | Carrier indicator | Carrier indicator |
| (RB and port-level RA) | Bandwidth part | Bandwidth part |
| | indicator | indicator |
| | Frequency domain | Frequency domain |
| | resource assignment | resource assignment |
| | Time domain | Time domain resource |
| | resource assignment | assignment |
| | TPC command for | Power coordination |
| | PUCCH | between backhaul |
| | | and access links |
| | Antenna ports | Antenna ports |
| | DMRS sequence | DMRS sequence |
| | initialization | initialization |
| | VRB to PRB | VRB to PRB |

In Table 5, an example of indicator for activation of the special transmission in the DCI may be NDI=0; DAI=0; and MCS=26; RV=01. An example of indicator for deactivation of the special transmission in the DCI may be NDI=0; DAI=0; and MCS=26; RV=01; HARQ=0000. It is understood that the specific values for these fields are merely examples, without any limitation on the present disclosure. Other examples are also possible. Also, it is noted that, regarding the field of “Antenna ports” as shown in Table 5, the maximum rank is 8 and possible non-transparent SU scheduling may use up to 12 DMRS ports.

Below Table 6 shows an example of the RRC configured Field, which may be used together with the example of DL-DCI for special scheduling as shown in Table 5.

TABLE 6
RRC configured Field
cg-DMRS-Configuration
Periodicity if for CS-RNTI

As another example of “RRC+DCI” method in Table 1, below Table 7 shows an example of special scheduling by UL-DCI.

TABLE 7

| BL UL-DCI Field | | |
|---|---|---|
| (C-RNTI, CS-RNTI) | | Usage in special scheduling |
| Indicator | | Special value for activation |
| for special | NDI, MCS, RV, | and deactivation of special |
| transmission | HARQ, DAT | transmission |
| DCI0_0 | Frequency domain | Frequency domain resource |
| (RB-level RA) | resource assignment | assignment |
| | Time domain resource | Time domain resource |
| | assignment | assignment |
| | TPC command for | Power coordination between |
| | scheduled PUSCH | backhaul and access links |
| DCI0_1 | Carrier indicator | Carrier indicator |
| (RB and port | Bandwidth part indicator | Bandwidth part indicator |
| level RA) | Frequency domain | Frequency domain resource |
| | resource assignment | assignment |
| | Time domain resource | Time domain resource |
| | assignment | assignment |
| | TPC command for | Power coordination between |
| | scheduled PUSCH | backhaul and access links |
| | SRS resource | DL/UL DMRS association |
| | indicator/TMPI | |
| | Antenna ports | |
| | DMRS sequence | DMRS sequence |
| | initialization | initialization |
| | VRB to PRB | VRB to PRB |

In Table 7, the indicator for special transmission may be the same as that in Table 5. As shown in Table 7, the available antenna ports indicated by the field of “Antenna ports” and “SRS resource indicator/TMPI” may be different from that can be indicated in the DL-DCI as shown in Table 5. Thus, when a UL-DCI for a backhaul link is reused to be as a DL-DCI indication for an access link, the DMRS indications in the “Antenna ports” field in the UL-DCI for the backhaul link may need to be converted to be DMRS indications in the “Antenna ports” field in the DL-DCI for the access link. This conversion may also be called as a DL/UL DMRS association in the context of the present disclosure.

Below Table 8 shows an example of a DL/UL DMRS association. In this example, the left part of the table is from DCI format 1_1 as specified in 3GPP specifications TS38.212V15.0.2, and the right part of the table is from DCI format 0_1 as specified in 3GPP specifications TS38.212V15.0.2. It is to be understood that this combined Table 8 is merely an example without any limitation on the present disclosure. In other embodiments, the DL/UL DMRS association may involve any other suitable DCI formats

TABLE 8
▪Antenna port(s) (1000 + DMRS port), dmrs-Type = 1, maxLength = 2

[symbol]

[symbol]

| ▪PDSCH | | | | PUSCH | | | | |
|---|---|---|---|---|---|---|---|---|
| | Number of | | | | Number of | | | |
| | DMRS CDM | | Number of | | DMRS CDM | | Number of | |
| | group(s) | DMRS | front-load | | group(s) | DMRS | front-load | [symbol] |
| ▪Value [symbol] | without data [symbol] | port(s) [symbol] | symbols [symbol] | Value [symbol] | without data [symbol] | port(s) [symbol] | symbols [symbol] | [symbol] |
| ▪ 0 [symbol] | 1 [symbol] | 0 [symbol] | 1 [symbol] | 0 [symbol] | 1 [symbol] | 0, 1 [symbol] | 1 [symbol] | [symbol] |
| ▪ 1 [symbol] | 1 [symbol] | 1 [symbol] | 1 [symbol] | 1 [symbol] | 2 [symbol] | 0, 1 [symbol] | 1 [symbol] | [symbol] |
| ▪ 2 [symbol] | 1 [symbol] | 0, 1 [symbol] | 1 [symbol] | 2 [symbol] | 2 [symbol] | 2, 3 [symbol] | 1 [symbol] | [symbol] |
| ▪ 3 [symbol] | 2 [symbol] | 0 [symbol] | 1 [symbol] | 3 [symbol] | 2 [symbol] | 0, 2 [symbol] | 1 [symbol] | [symbol] |
| ▪ 4 [symbol] | 2 [symbol] | 1 [symbol] | 1 [symbol] | 4 [symbol] | 2 [symbol] | 0, 1 [symbol] | 2 [symbol] | [symbol] |
| ▪ 5 [symbol] | 2 [symbol] | 2 [symbol] | 1 [symbol] | 5 [symbol] | 2 [symbol] | 2, 3 [symbol] | 2 [symbol] | [symbol] |
| ▪ 6 [symbol] | 2 [symbol] | 3 [symbol] | 1 [symbol] | 6 [symbol] | 2 [symbol] | 4, 5 [symbol] | 2 [symbol] | [symbol] |
| ▪ 7 [symbol] | 2 [symbol] | 0, 1 [symbol] | 1 [symbol] | 7 [symbol] | 2 [symbol] | 6, 7 [symbol] | 2 [symbol] | [symbol] |
| ▪ 8 [symbol] | 2 [symbol] | 2, 3 [symbol] | 1 [symbol] | 8 [symbol] | 2 [symbol] | 0, 4 [symbol] | 2 [symbol] | [symbol] |
| ▪ 9 [symbol] | 2 [symbol] | 0-2 [symbol] | 1 [symbol] | 9 [symbol] | 2 [symbol] | 2, 6 [symbol] | 2 [symbol] | [symbol] |
| ▪ 10 [symbol] | 2 [symbol] | 0-3 [symbol] | 1 [symbol] | 10-15 [symbol] | Reserved [symbol] | Reserved [symbol] | Reserved [symbol] | [symbol] |
| ▪ 11 [symbol] | 2 [symbol] | 0, 2 [symbol] | 1 [symbol] | [symbol] | [symbol] | [symbol] | [symbol] | [symbol] |
| ▪ 20 [symbol] | 2 [symbol] | 0, 1 [symbol] | 2 [symbol] | [symbol] | [symbol] | [symbol] | [symbol] | [symbol] |
| ▪ 21 [symbol] | 2 [symbol] | 2, 3 [symbol] | 2 [symbol] | [symbol] | [symbol] | [symbol] | [symbol] | [symbol] |
| ▪ 22 [symbol] | 2 [symbol] | 4, 5 [symbol] | 2 [symbol] | [symbol] | [symbol] | [symbol] | [symbol] | [symbol] |
| ▪ 23 [symbol] | 2 [symbol] | 8, 7 [symbol] | 2 [symbol] | [symbol] | [symbol] | [symbol] | [symbol] | [symbol] |
| ▪ 24 [symbol] | 2 [symbol] | 0, 4 [symbol] | 2 [symbol] | [symbol] | [symbol] | [symbol] | [symbol] | [symbol] |
| ▪ 25 [symbol] | 2 [symbol] | 2, 6 [symbol] | 2 [symbol] | [symbol] | [symbol] | [symbol] | [symbol] | [symbol] |

[symbol]

As shown in Table 8, each UL DMRS indication for the backhaul link may be mapped to a DL DMRS indication for the access link in a one-to-one manner. For example, the first row of the “PUSCH” on the right, that is, value 0 indicating “1, (0,1), 1” may be mapped to the third row of the “PDSCH” on the left, that is, value 2 indicating the same “1, (0,1), 1.” Similarly, other values in the “PUSCH” on the right can be mapped to the values in the “PDSCH” on the left in a one-to-one manner.

As an example of “C-RNTI/CS-RNTI DCI” method in Table 1, a new DCI format may be designed for both of the first data transmission (denoted as S1) and the second data transmission (denoted as S2). An example of this kind of new DCI format is shown in Table 9 as below. It is noted that two sets of DMRS ports are indicated and there are at least two transmission blocks (TBs) in a PUSCH.

TABLE 9

| | | | | Usage in |
|---|---|---|---|---|
| BL DCI Field | | | | special |
| (C-RNTI, CS-RNTI) | | | | scheduling |
| RB and | Carrier indicator | | | Both for S1 |
| port-level | | | | and S2 |
| RA | Bandwidth part indicator | | | Both for S1 |
| | | | | and S2 |
| | Frequency domain resource assignment | | | Both for S1 |
| | | | | and S2 |
| | Time domain resource assignment | | | Both for S1 |
| | | | | and S2 |
| | TPC command for scheduled PUSCH | | | Both for S1 |
| | | | | and S2 |
| | DMRS set 1 | SRS resource indicator/TMPI | | For S1 if |
| | | Antenna ports | | configured |
| | | Option 1 | Option 2 | |
| | DMRS set 2 | SRS resource | Or DL | For S2 if |
| | | indicator/TMPI | DMRS | configured |
| | | Antenna ports | Antenna | |
| | | | ports | |
| | DMRS sequence initialization | | | Both for S1 |
| | | | | and S2 |
| | VRB to PRB | | | Both for S1 |
| | | | | and S2 |

| | |
|---|---|
| Others | For S1 |

In some embodiments, the special scheduling information may be transmitted with a compact DCI, which may be specially designed for the special scheduling. An example of such a compact DCI is shown as below in Table 10. In can be seen that, the compact DCI may only include several necessary fields for the special scheduling, and may not include other fields which are included in existing DCI formats but are unnecessary for the special scheduling.

TABLE 10
Special Scheduling
(C-RNTI, CS-RNTI DCI based DCI Field)

| Field | Indication for special transmission | |
|---|---|---|
| | Frequency domain resource assignment | |
| | Time domain resource assignment | |
| | Others | Antenna Ports |
| | | TPC commands |
| | | TCI states |

In some embodiments, the special scheduling may be based on a slot level. In this event, there may be a scheduling period, for example, specified by a RRC message. The scheduling period may be divided into slots, each of which may be allocated to a backhaul link or an access link and may be used for uplink transmission or downlink transmission.

In such embodiments, the special scheduling information may have a first field to indicate whether a particular slot is to be used for a backhaul link or an access link. Additionally, the special scheduling information may have a second field to indicate a DL/UL slot bitmap if the particular slot is allocated to the access link. In contrast, if the particular slot is allocated to the backhaul link, the second field may be omitted, and thus the signaling overhead may be reduced. Table 11 as below shows an example of such slot-level special scheduling signaling.

TABLE 11

| BL Special Scheduling | | |
|---|---|---|
| (GC DCI Field) | | Value |
| Field | Indication for special transmission | “0” = backhaul link; |
| | | “1” = access link |
| | Access link DL/UL slot format | bitmap |

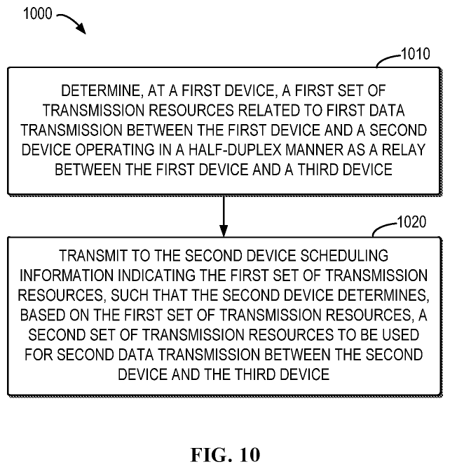

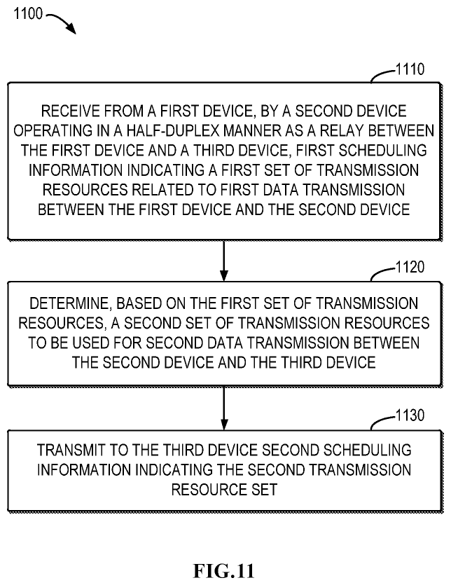

FIG. 10 shows a flowchart of an example method 1000 in accordance with some embodiments of the present disclosure. The method 1000 can be implemented by a device, such as the first device 110 as shown in FIG. 1. For ease of illustration, example embodiments of the method 1000 will be described with reference to FIG. 1.

At 1010, the first device 110 determines a first set of transmission resources related to first data transmission between the first device 110 and a second device operating in a half-duplex manner as a relay between the first device 110 and a third device.

At 1020, the first device 110 transmits to the second device scheduling information indicating the first set of transmission resources, such that the second device determines, based on the first set of transmission resources, a second set of transmission resources to be used for second data transmission between the second device and the third device.

In some embodiments, determining the first set of transmission resources may comprise: determining a set of transmission resources to be used for the first data transmission as the first set of transmission resources; or determining a set of transmission resources not to be used for the first data transmission as the first set of transmission resources.

In some embodiments, the method 1000 may further comprise: in response to the second data transmission being transmission from the second device to the third device, transmitting to the second device further scheduling information indicating a third set of transmission resources to be used for transmission from the second device to the first device, the third set of transmission resources comprising same time and frequency resources as and a different spatial resource from the second set of transmission resources; or indicating the third set of transmission resources in the scheduling information.

In some embodiments, the method 1000 may further comprise at least one of: in response to receiving from the second device a scheduling request for requesting the first device to schedule the first set of transmission resources, determining the first set of transmission resources; and in response to receiving from the second device information indicating that the second set of transmission resources is insufficient for the second data transmission, transmitting to the second device updated first scheduling information indicating an updated first set of transmission resources, which results in an updated second set of transmission resources comprising more transmission resources than the second set of transmission resources.

In some embodiments, the method 1000 may further comprise: obtaining a first path loss estimate of a first communication link between the first device and the second device; requesting, from the second device, a second path loss estimate of a second communication link between the second device and the third device; receiving the second path loss estimate from the second device; determining, based on at least one of the first and second path loss estimates, a power control for transmission from the second communication to the third device; and indicating the determined power control in the scheduling information.

In some embodiments, the method 1000 may further comprise: receiving from the second device a power coordination request for requesting the first device to adjust transmission power of transmission from the first device to the second device; in response to determining that the transmission power is to be adjusted, transmitting to the second device confirmation for the power coordination request; and transmitting to the second device with the adjusted power.

In some embodiments, the method 1000 may further comprise: receiving from the second device confirmation for the scheduling information.

In some embodiments, the method 1000 may further comprise: transmitting to the second device a deactivation indication for deactivating the scheduling information; and receiving from the second device confirmation for the deactivation indication.

In some embodiments, transmitting the scheduling information may comprise: indicating the scheduling information in at least one of a radio resource control (RRC) message, a medium access control-control element (MAC-CE), downlink control information (DCI), and dedicated DCI.

FIG. 11 shows a flowchart of another example method 1100 in accordance with some embodiments of the present disclosure. The method 1100 can be implemented by a device, such as the second device 120 as shown in FIG. 1. For ease of illustration, example embodiments of the method 1100 will be described with reference to FIG. 1.

At 1110, the second device 120, which operates in a half-duplex manner as a relay between a first device and a third device, receives from the first device first scheduling information indicating a first set of transmission resources related to first data transmission between the first device and the second device 120.

At 1120, the second device 120 determines, based on the first set of transmission resources, a second set of transmission resources to be used for second data transmission between the second device 120 and the third device.

At 1130, the second device 120 transmits to the third device second scheduling information indicating the second set of transmission resources.

In some embodiments, determining the second set of transmission resources may comprise: in response to the first set of transmission resources being a set of transmission resources to be used for the first data transmission, determining a complementary set of the first set of transmission resources with respect to a universal set of all available transmission resources; or in response to the first set of transmission resources being a set of transmission resources not to be used for the first data transmission, determining a subset of the first set of transmission resources.

In some embodiments, the method 1100 may further comprise: determining, from the first scheduling information or further scheduling information from the first device, a third set of transmission resources to be used for transmission from the second device to the first device, the third set of transmission resources comprising same time and frequency resources as and a different spatial resource from the second set of transmission resources; and transmitting to the first device using the third set of transmission resources and to the third device using the second set of transmission resources.

In some embodiments, the method 1100 may further comprise at least one of: transmitting to the first device a scheduling request for requesting the first device to schedule the first set of transmission resources; and in response to determining that the second set of transmission resources is insufficient for the second data transmission, transmitting to the first device information indicating that the second set of transmission resources is insufficient.

In some embodiments, the method 1100 may further comprise: in response to receiving from the first device a request for requesting a path loss estimate of a communication link between the second device and the third device, transmitting the path loss estimate to the first device; obtaining, from the scheduling information, a first power control for transmission from the second communication to the third device; and applying the first power control to the transmission from the second communication to the third device.

In some embodiments, the method 1100 may further comprise: transmitting to the first device a power coordination request for requesting the first device to adjust transmission power of transmission from the first device to the second device; in response to receiving from the first device confirmation for the power coordination request, indicating a second power control in the second scheduling information; and receiving from the first device with the adjusted power and from the third device with power under the second power control.

In some embodiments, the method 1100 may further comprise: in response to receiving the first scheduling information, transmitting to the first device confirmation for the first scheduling information.

In some embodiments, the method 1100 may further comprise: receiving from the first device a deactivation indication for deactivating the first scheduling information; and transmitting to the first device confirmation for the deactivation indication.

In some embodiments, receiving the first scheduling information may comprise: obtaining the first scheduling information from at least one of a radio resource control (RRC) message, a medium access control-control element (MAC-CE), downlink control information (DCI), and dedicated DCI.

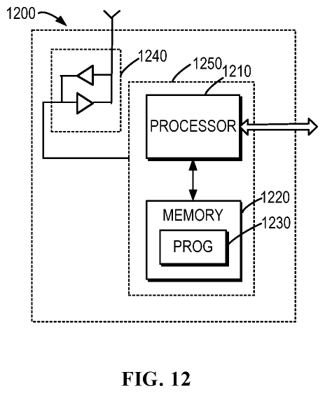

FIG. 12 is a simplified block diagram of a device 1200 that is suitable for implementing some embodiments of the present disclosure. The device 1200 can be considered as a further example embodiment of the first, second, and third devices 110, 120, and 130 as shown in FIG. 1. Accordingly, the device 1200 can be implemented at or as at least a part of the first, second, and third devices 110, 120, and 130.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIG. 10 or 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 5 and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communication, comprising:
determining, at a first device, a first set of transmission resources related to first data transmission between the first device and a second device operating in a half-duplex manner as a relay between the first device and a third device; and
transmitting to the second device scheduling information indicating the first set of transmission resources, such that the second device determines, based on the first set of transmission resources, a second set of transmission resources to be used for second data transmission between the second device and the third device.

2. The method of claim 1, wherein determining the first set of transmission resources comprises:
determining a set of transmission resources to be used for the first data transmission as the first set of transmission resources; or
determining a set of transmission resources not to be used for the first data transmission as the first set of transmission resources.

3. The method of claim 1, further comprising:
in response to the second data transmission being transmission from the second device to the third device,
transmitting to the second device further scheduling information indicating a third set of transmission resources to be used for transmission from the second device to the first device, the third set of transmission resources comprising same time and frequency resources as and a different spatial resource from the second set of transmission resources; or
indicating the third set of transmission resources in the scheduling information.

4. The method of claim 1, further comprising at least one of:
in response to receiving from the second device a scheduling request for requesting the first device to schedule the first set of transmission resources, determining the first set of transmission resources; and
in response to receiving from the second device information indicating that the second set of transmission resources is insufficient for the second data transmission, transmitting to the second device updated first scheduling information indicating an updated first set of transmission resources, which results in an updated second set of transmission resources comprising more transmission resources than the second set of transmission resources.

5. The method of claim 1, further comprising:
obtaining a first path loss estimate of a first communication link between the first device and the second device;
requesting, from the second device, a second path loss estimate of a second communication link between the second device and the third device;
receiving the second path loss estimate from the second device;
determining, based on at least one of the first and second path loss estimates, a power control for transmission from the second communication to the third device; and
indicating the determined power control in the scheduling information.

6. The method of claim 1, further comprising:
receiving from the second device a power coordination request for requesting the first device to adjust transmission power of transmission from the first device to the second device;
in response to determining that the transmission power is to be adjusted, transmitting to the second device confirmation for the power coordination request; and
transmitting to the second device with the adjusted power.

7. The method of claim 1, further comprising:
receiving from the second device confirmation for the scheduling information.

8. The method of claim 1, further comprising:
transmitting to the second device a deactivation indication for deactivating the scheduling information; and
receiving from the second device confirmation for the deactivation indication.

9. The method of claim 1, wherein transmitting the scheduling information comprises:
indicating the scheduling information in at least one of a radio resource control (RRC) message, a medium access control-control element (MAC-CE), downlink control information (DCI), and dedicated DCI.

10. A method for communication, comprising:
receiving from a first device, by a second device operating in a half-duplex manner as a relay between the first device and a third device, first scheduling information indicating a first set of transmission resources related to first data transmission between the first device and the second device;
determining, based on the first set of transmission resources, a second set of transmission resources to be used for second data transmission between the second device and the third device; and
transmitting to the third device second scheduling information indicating the second set of transmission resources.

11. The method of claim 10, wherein determining the second set of transmission resources comprises:
in response to the first set of transmission resources being a set of transmission resources to be used for the first data transmission, determining a complementary set of the first set of transmission resources with respect to a universal set of all available transmission resources; or
in response to the first set of transmission resources being a set of transmission resources not to be used for the first data transmission, determining a subset of the first set of transmission resources.

12. The method of claim 10, further comprising:
determining, from the first scheduling information or further scheduling information from the first device, a third set of transmission resources to be used for transmission from the second device to the first device, the third set of transmission resources comprising same time and frequency resources as and a different spatial resource from the second set of transmission resources; and
transmitting to the first device using the third set of transmission resources and to the third device using the second set of transmission resources.

13. The method of claim 10, further comprising at least one of:
transmitting to the first device a scheduling request for requesting the first device to schedule the first set of transmission resources; and
in response to determining that the second set of transmission resources is insufficient for the second data transmission, transmitting to the first device information indicating that the second set of transmission resources is insufficient.

14. The method of claim 10, further comprising:
in response to receiving from the first device a request for requesting a path loss estimate of a communication link between the second device and the third device, transmitting the path loss estimate to the first device;
obtaining, from the scheduling information, a first power control for transmission from the second communication to the third device; and
applying the first power control to the transmission from the second communication to the third device.

15. The method of claim 10, further comprising:
transmitting to the first device a power coordination request for requesting the first device to adjust transmission power of transmission from the first device to the second device;
in response to receiving from the first device confirmation for the power coordination request, indicating a second power control in the second scheduling information; and
receiving from the first device with the adjusted power and from the third device with power under the second power control.

16. The method of claim 10, further comprising:
in response to receiving the first scheduling information, transmitting to the first device confirmation for the first scheduling information.

17. The method of claim 10, further comprising:
receiving from the first device a deactivation indication for deactivating the first scheduling information; and
transmitting to the first device confirmation for the deactivation indication.

18. The method of claim 10, wherein receiving the first scheduling information comprises:
obtaining the first scheduling information from at least one of a radio resource control (RRC) message, a medium access control-control element (MAC-CE), downlink control information (DCI), and dedicated DCI.

19. A first device comprising:
a processor; and
a memory storing instructions,
the memory and the instructions being configured, with the processor, to cause the first device to:
determine a first set of transmission resources related to first data transmission between the first device and a second device operating in a half-duplex manner as a relay between the first device and a third device; and
transmit to the second device scheduling information indicating the first set of transmission resources, such that the second device determines, based on the first set of transmission resources, a second set of transmission resources to be used for second data transmission between the second device and the third device.

20-22. (canceled)

23. The first device of claim 19, wherein the first device is caused to determine the first set of transmission resources by:
determining a set of transmission resources to be used for the first data transmission as the first set of transmission resources; or
determining a set of transmission resources not to be used for the first data transmission as the first set of transmission resources.
